(19) United States
(12) Patent Application Publication
(10) Pub. No.: US 2025/0147296 A1
(43) Pub. Date: May 8, 2025

(54) INSTANT POLARIZED LIGHT MICROSCOPE

(71) Applicants: University of Southampton, Southampton (GB); The Marine Biological Laboratory, Woods Hole, MA (US)

(72) Inventors: Michael Shribak, Falmouth, MA (US); Peter Kazansky, Eastleigh (GB)

(21) Appl. No.: 18/832,643

(22) PCT Filed: Feb. 3, 2023
(86) PCT No.: PCT/US23/61999

§ 371 Date: Jul. 24, 2024

Related U.S. Application Data
(60) Provisional application No. 63/306,604, filed on Feb. 4, 2022.

(51) Int. Cl. G02B 21/00; G02B 21/36

(52) U.S. Cl. CPC G02B 21/0092; G02B 21/361; G02B 21/365

(57) ABSTRACT

A polarized light microscope includes a light source configured to illuminate a specimen and an imaging sensor configured to capture an image of the specimen. The polarized light microscope also includes a first circular polarizer positioned between the light source and the specimen. A birefringent mosaic mask is positioned between the specimen and the imaging sensor. The polarized light microscope also includes a second polarizer positioned between the mask and the imaging sensor.

### CROSS-REFERENCE TO RELATED APPLICATION

The present application claims the priority benefit of U.S. Provisional Patent App. No. 63/306,604 filed on Feb. 4, 2022, the entire contents of which are incorporated by reference herein.

### STATEMENT REGARDING FEDERALLY SPONSORED RESEARCH

This invention was made with government support under GM101701 awarded by the National Institutes of Health. The government has certain rights in the invention.

### BACKGROUND

Polarized light microscopy (PLM) has been widely used for two centuries, since development of the first polarizing microscope in 1834 by Henry Talbot. A PLM system introduces contrast into a would-be invisible specimen if the specimen contains molecules or structures that are birefringent. A PLM microscope generates the polarized probe beam and converts a change in the azimuth and/or ellipticity of polarization, which is introduced by the specimen under investigation, into a change in color and/or intensity, and allows geologists, physicists, chemists, biologists and engineers to study birefringent specimens. The PLM microscope was originally constructed for the petrographic examination of thin slices of rocks, but in recent years it has assumed increasing importance in the fields of chemistry, ceramic technology, metallography, crime detection, military intelligence, biology, and medicine.

### SUMMARY

An illustrative polarized light microscope includes a light source configured to illuminate a specimen and an imaging sensor configured to capture an image of the specimen. The polarized light microscope also includes a first circular polarizer positioned between the light source and the specimen. A birefringent mosaic mask is positioned between the specimen and the imaging sensor. The polarized light microscope also includes a second polarizer positioned between the mask and the imaging sensor.

In one embodiment, the second polarizer and the birefringent mosaic mask are attached to the imaging sensor. In another embodiment, the second polarizer and the birefringent mosaic mask are positioned in a plane that is conjugated with the image sensor. The system can also include an objective lens positioned between the specimen and the birefringent mosaic mask. In another embodiment, the second polarizer comprises a circular polarizer. In one embodiment, the second polarizer comprises a right circular polarizer, and the first polarizer comprises a left circular polarizer.

In one embodiment, a superpixel of the birefringent mosaic mask includes a first square (or pixel), a second square (or pixel), a third square (or pixel), and a fourth square (or pixel) that have a retardation range from 0 to 0.25λ. In one implementation of such an embodiment, the first square is not birefringent, and the second square, the third square, and the fourth square have the same retardation, which lies in a range from 0.01λ to 0.25λ. Also, the second square has slow axis orientation of 0°, the third square has slow axis orientation of 60°, and the fourth square has slow axis orientation of 120°. Alternatively, the second square has slow axis orientation of 0°, the third square has slow axis orientation of 45°, and the fourth square has slow axis orientation of 90°. In another alternative configuration, the first square, the second square, the third square, and the fourth square have the same retardation, which lies in a range from 0.01λ to 0.25λ, and the first square has slow axis orientation of 0°, the second square has slow axis orientation of 45°, the third square has slow axis orientation of 90°, and the fourth square has slow axis orientation of 135°.

In one embodiment, the birefringent mosaic mask includes two sets of superpixels. In another embodiment, the birefringent mosaic mask is fabricated by way of laser pulses directed inside a quartz substrate. Alternatively, the birefringent mosaic mask can be formed by a nanostructured surface. The birefringent mosaic mask can also be constructed from micro tiles made of a birefringent film.

An illustrative instant imaging full Stokes polarimeter includes a polarization image sensor that has a polarization mosaic mask and an imaging sensor. The polarimeter also includes a birefringent mosaic mask proximate to the polarization image sensor. The birefringent mosaic mask includes a plurality of birefringent superpixels, and each birefringent superpixel is formed of one or more pixels with no birefringence and one or more birefringent pixels. The polarimeter also includes a processor operatively coupled to the polarization image sensor. The processor is configured to process a plurality of intensity signals generated by a superpixel of the imaging sensor to identify Stokes parameters of an image captured by the imaging sensor.

In one embodiment, the polarizer comprises a polarization mosaic mask that includes a plurality of polarization superpixels, and each polarization superpixel includes a plurality of micropolarizers. In another embodiment, the polarizer comprises a circular polarizer. In another embodiment, the birefringent mosaic mask is attached to one or more of the imaging sensor and the polarizer. In one embodiment, the birefringent mosaic mask includes two sets of superpixels. In another embodiment, each birefringent superpixel includes six pixels.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings.

FIG. 1A depicts a pattern of a first birefringent mosaic mask in accordance with an illustrative embodiment.

FIG. 1B depicts an example of an elementary group of four mosaic squares, which can be called a superpixel, with hash marks indicating the retardance and slow axis orientation of the first birefringent mosaic mask in accordance with an illustrative embodiment.

FIG. 2A depicts a pattern of a second birefringent mosaic mask in accordance with an illustrative embodiment.

FIG. 2B depicts an example of an elementary group of four mosaic squares, which can be called a superpixel, with hash marks indicating the retardance and slow axis orientation of the second birefringent mosaic mask in accordance with an illustrative embodiment.

FIG. 3A depicts a pattern of a third birefringent mosaic mask in accordance with an illustrative embodiment.

FIG. 3B depicts an elementary group of four mosaic squares with colors indicating the retardance and slow axis orientation of the third birefringent mosaic mask in accordance with an illustrative embodiment.

FIG. 4A depicts a pattern of a fourth birefringent mosaic mask in accordance with an illustrative embodiment.

FIG. 4B depicts an elementary group of four mosaic squares with colors indicating the retardance and slow axis orientation of the fourth birefringent mosaic mask in accordance with an illustrative embodiment.

FIG. 5A illustrates a case of the first birefringent mosaic mask configuration implemented with two elementary groups in accordance with an illustrative embodiment.

FIG. 5B depicts four variants of an elementary group with four (2×2) mosaic squares in accordance with an illustrative embodiment.

FIG. 5C depicts an elementary group with sixteen (4×4) mosaic squares in accordance with an illustrative embodiment.

FIG. 6 depicts an example of an instant polarized light microscope with a birefringent mosaic mask and circular polarizer directly attached to the image sensor (photodiode array) in accordance with an illustrative embodiment.

FIG. 7 depicts an example of an instant polarized light microscope in which the birefringent mosaic mask and circular polarizer are placed in a plane that is conjugated with the image sensor (i.e., intermediate image plane) in accordance with an illustrative embodiment.

FIG. 8 is a schematic of an instant polarized light microscope with a reflected light path in accordance with an illustrative embodiment.

FIG. 9 depicts a birefringent mosaic mask written (nanofabricated) by laser pulses inside a quartz substrate in accordance with an illustrative embodiment.

FIG. 10 depicts an instant polarized light microscope with a birefringent mosaic mask and a polarization image sensor in accordance with an illustrative embodiment.

FIG. 11 depicts a pattern of a first birefringent mosaic mask for full Stokes polarization parameter imaging in accordance with an illustrative embodiment.

FIG. 12 depicts a pattern of a second birefringent mosaic mask for full Stokes polarization parameter imaging in accordance with an illustrative embodiment.

FIG. 13A depicts a pattern of a third birefringent mosaic mask for full Stokes polarization parameter imaging in accordance with an illustrative embodiment.

FIG. 13B depicts two superpixels of the birefringent mosaic mask in accordance with an illustrative embodiment.

FIG. 13C depicts two sets of six signals, which are generated by two superpixels of the birefringent mosaic mask, in accordance with an illustrative embodiment.

FIG. 14 is a block diagram of a computing system to implement a microscope imaging system in accordance with an illustrative embodiment.

### DETAILED DESCRIPTION

Over the last three decades, several schemes have been proposed to automate the measurement process and exploit more fully the analytic power of a polarizing microscope. These schemes invariably involve use of a traditional compensator, which is either rotated under computer control or replaced by electro-optical modulators, such as Pockels cells, Faraday rotators, and liquid crystal variable retarders. Alternatively, some traditional systems split the imaging beam and simultaneously capture several images, analyzing each for a different polarization state. These schemes also involve quantitative intensity measurements using electronic light detectors, such as photomultipliers or digital cameras. More recently, quantitative instant polarized light microscopes (PLMs) have become available, which employ a charge-coupled device (CCD) chip with a mosaic polarizing mask. These traditional PLMs use a four-frame algorithm with linear polarization settings. However, this approach has inherently low signal-to-noise ratio in scenarios that involve measurement of weak birefringent samples such as spindles in dividing cells, collagen fibers, nano-fabricated structures in optical information carriers, etc. Additionally, traditional PLM only reveals anisotropic structures that have a limited range of orientations with respect to the polarization axis of the microscope. Furthermore, the use of a traditional compensator involves an inordinate amount of time for measuring optical anisotropies such as birefringence.

The inventors have proposed algorithms with elliptical polarization settings and have built two types of high-sensitive quantitative PLMs with single- or dual-liquid crystal polarization state generators. These PLMs, which are referred to as LC-polscopes, measure the birefringent fine structure simultaneously over an entire field of view, for all orientations of the birefringence axis, at high sensitivity (e.g., 0.02 nanometers (nm) birefringence retardation), high resolution (e.g., 0.2 micrometers (μm)), and in fast time intervals (e.g., 1 second).

Described herein is an instant polarized light microscope that will provide the same high sensitivity as LC-polscope. However, the proposed instant polarized light microscope is free of artifacts caused by the movement of specimen structures during the image acquisition. The proposed microscope will also be more robust and less expensive than existing systems because, in an illustrative embodiment, it will not utilize liquid crystal optics with electronic controllers. The proposed microscope can also be used over a wider spectral range and in much more harsh environmental conditions than existing systems due to the absence of liquid crystal components. The proposed microscope is well suited for mass production and wide use in science, education, and industry. The proposed microscope is also more user friendly because it eliminates recalibration caused by the drift of retardation of liquid crystal optics.

In an illustrative embodiment, the proposed instant polarized light microscope utilizes a birefringent assembly, which includes a birefringent mosaic mask and a polarizer. The birefringent mosaic mask can include four nearly circular polarization filters in one embodiment. In another embodiment, the birefringent mosaic mask can include three nearly circular polarization filters and one circular polarization filter. The inventors have proposed various basic configurations of the mosaic mask, which are designed to work with specific algorithms for computing of a two-dimensional retardance map. In the images (described below) depicting mosaic masks, one birefringent mosaic square corresponds to one pixel on an image sensor.

The proposed birefringent mosaic masks differ from traditional masks in a number of ways. For example, some polarization image sensors are created by a linear polarizer mosaic mask and a photodiode array. In such a mask, there are four pixels with wire-grid linear polarizers, and having transmission planes oriented at 0°, 45°, 90°, and 135°. As discussed in more detail below, the proposed birefringent mosaic masks differ from such traditional systems in configuration, retardation, and slow axis orientation.

The proposed birefringent mosaic mask can be fabricated in many ways. For example, the mask can be written (nanofabricated) by laser pulses inside a quartz substrate. The mask can be also formed by a nanostructured surface, patterned liquid crystal array, patterned photonic crystal array, or constructed from micro tiles made of a birefringent film.

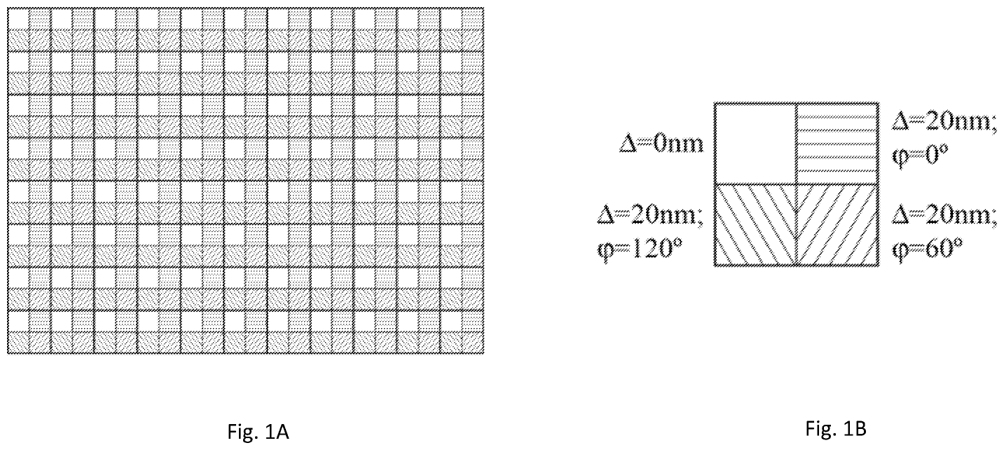

FIG. 1 shows a first mosaic mask configuration. Specifically, FIG. 1A depicts a pattern of a first birefringent mosaic mask in accordance with an illustrative embodiment. FIG. 1B depicts an example of an elementary group of four mosaic squares, which can be called a superpixel, with hash marks indicating the retardance and slow axis orientation of the first birefringent mosaic mask in accordance with an illustrative embodiment. In the figures, delta refers to retardation and psi refers to slow axis orientation. In the embodiment of FIG. 1, the empty/white squares of the mask are not birefringent and have retardation of 0 nm. The squares with horizontal lines have retardation of 20 nm (˜0.03λ) and slow axis orientation of 0°, the squares with lines of positive slope have retardation of 20 nm and slow axis orientation of 60°, and the squares with lines of negative slope have retardation of 20 nm and slow axis orientation of 120°. The mosaic mask of FIG. 1 is designed to work with a new modified symmetrical three-frame algorithm and an additional extinction setting.

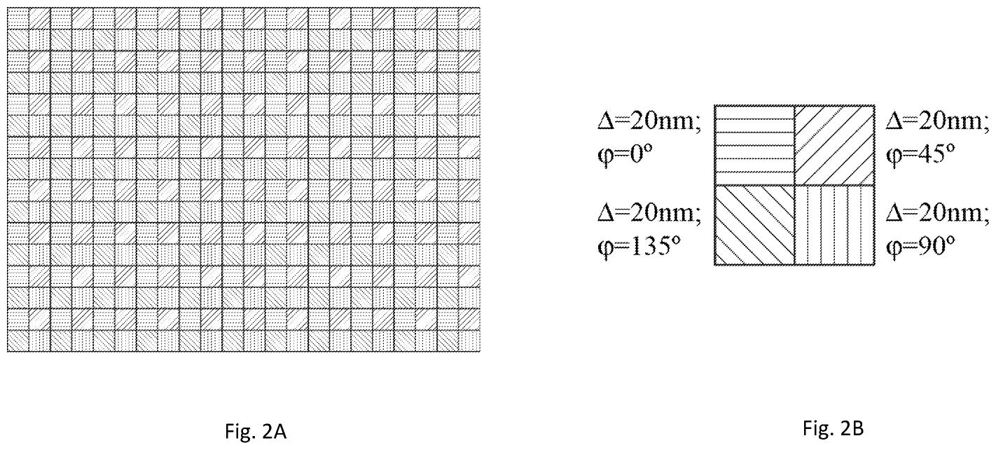

FIG. 2A depicts a pattern of a second birefringent mosaic mask in accordance with an illustrative embodiment. FIG. 2B depicts an elementary group of four mosaic squares with colors indicating the retardance and slow axis orientation of the second birefringent mosaic mask in accordance with an illustrative embodiment. The proposed second birefringent mosaic mask is designed to function with a symmetrical four-frame algorithm. As shown, the mask superpixel includes four pixels with retardation of 20 nm (˜0.03λ). The direction of hatch pattern depicts the slow axis orientation φ, 0°, 45°, 90°, and 135°.

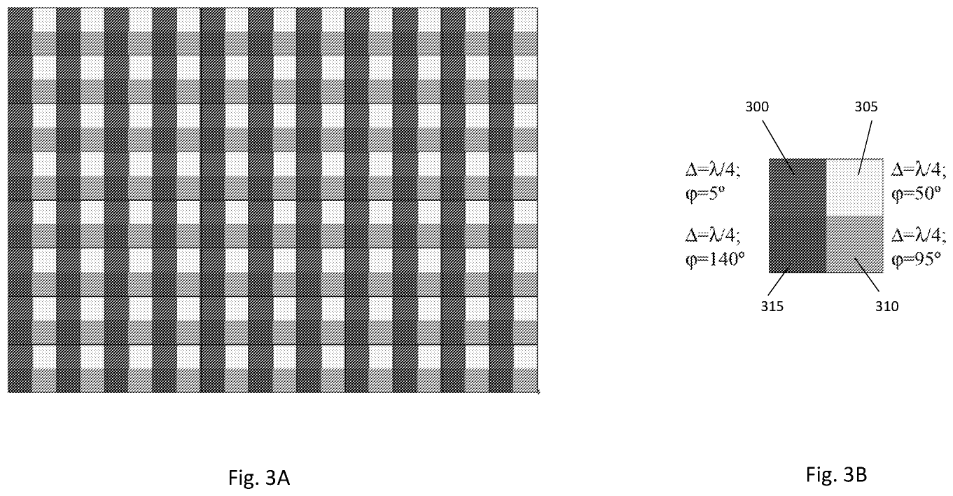

FIG. 3A depicts a pattern of a third birefringent mosaic mask in accordance with an illustrative embodiment. FIG. 3B depicts an elementary group of four mosaic squares with colors indicating the retardance and slow axis orientation of the third birefringent mosaic mask in accordance with an illustrative embodiment. In an illustrative embodiment, the birefringent mosaic mask of FIG. 3A can be added to a polarization image sensor (e.g., a Sony polarization image sensor), in order be used in a quantitative instant polarized light microscope. This design does not involve use of a circular polarizer. As shown in FIG. 3B, the mask superpixel includes four pixels with retardation of 0.25λ. The slow axis orientation φ of the superpixel is φ=5° at a first pixel location 300, φ=50° at a second pixel location 305, φ=95° at a third pixel location 310, and φ=140° at a fourth pixel location 315.

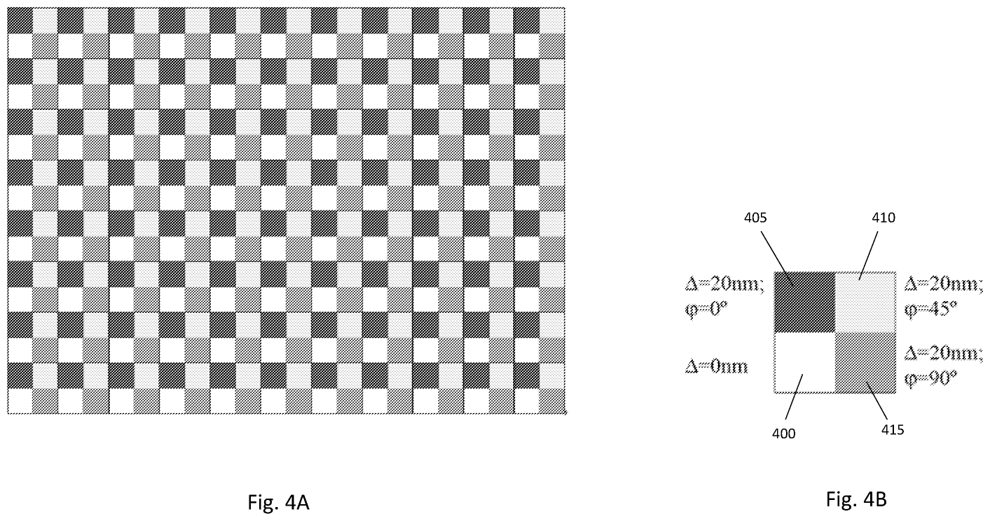

FIG. 4A depicts a pattern of a fourth birefringent mosaic mask in accordance with an illustrative embodiment. FIG. 4B depicts an elementary group of four mosaic squares with colors indicating the retardance and slow axis orientation of the fourth birefringent mosaic mask in accordance with an illustrative embodiment. In the embodiment of FIG. 4, the white squares of the mask are not birefringent. The mask superpixel includes four pixels, three of which are shaded pixels having a retardation of 20 nm (˜0.03λ) and a white pixel (at a first pixel location 400) with no retardation. The superpixel has a slow axis orientation of 0° at a second pixel location 405, 45° at a third pixel location 410, and 90° at a fourth pixel location 415. The proposed third birefringent mosaic mask is designed to function with a non-symmetrical four frame algorithm, which includes an extinction setting. It is noted that this algorithm is less sensitive and that its sensitivity depends on the specimen orientation. In alternative embodiments, additional birefringent mosaic mask configurations that function with four frame algorithms may be used. It is also possible to create additional mask configurations for two-, three-, and five-frame algorithms, however such configurations are not considered to be optimal and have not been found to provide additional benefits.

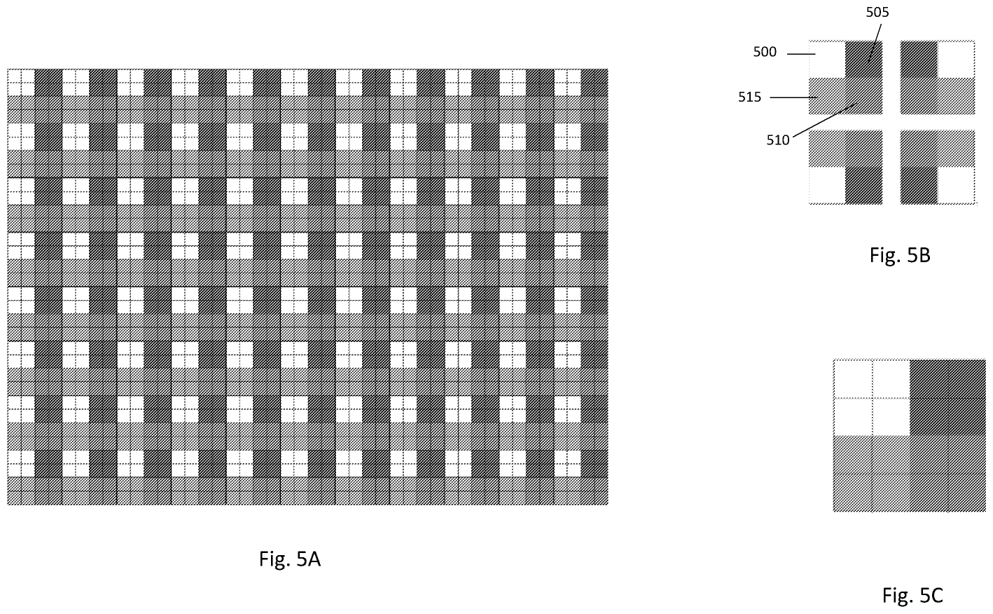

Similar to a Bayer color filter array (e.g., a red filter, a blue filter, and two green filters), the proposed birefringent masks can be implemented in many various ways. For example, FIG. 5A illustrates a case of the first birefringent mosaic mask configuration implemented with two elementary groups in accordance with an illustrative embodiment. The smaller group covers a 2×2 pixel area, and the larger group covers a 4×4 pixel area. Therefore, this mask is able to work in two modes, (1) with high resolution when more light is available; and (2) with high sensitivity when the illumination is weaker. FIG. 5B depicts four variants of an elementary group with four (2×2) mosaic squares in accordance with an illustrative embodiment. FIG. 5C depicts an elementary group with sixteen (4×4) mosaic squares in accordance with an illustrative embodiment. In the embodiment of FIG. 5, the white square 500 is not birefringent, a first shaded square (e.g., red) 505, a second shaded square (e.g., green) 510, and a third shaded square (e.g., blue) 515 have retardance of 20 nm (˜0.03λ) and slow axis orientation of 0°, 60°, and 120°, respectively. As illustrated, the neighboring mosaic squares can be combined into one larger unit.

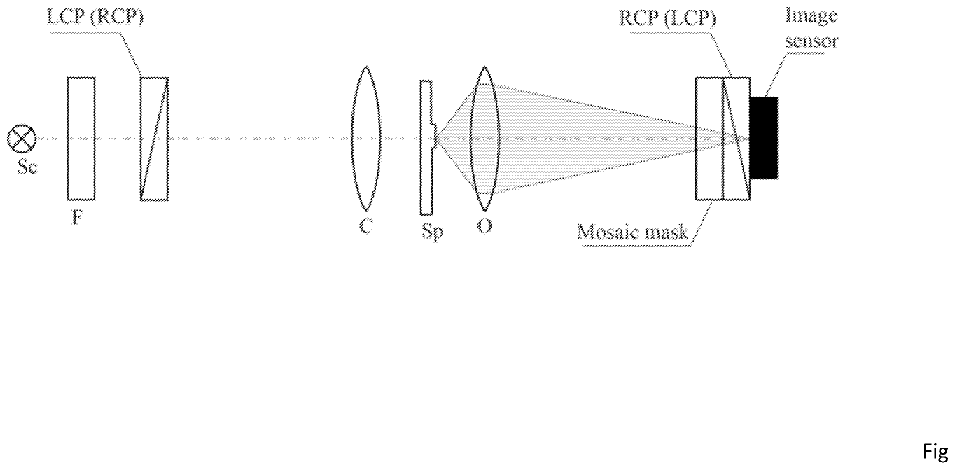

Principle schemes of an instant polarized light microscope with birefringent mosaic mask are described below. In an illustrative embodiment, the proposed birefringent mosaic mask is placed into a polarizing microscope between orthogonal circular or near circular polarizers. The mosaic squares are placed either directly on the image sensor or in a sensor conjugated plane. FIG. 6 depicts an example of an instant polarized light microscope with a birefringent mosaic mask and circular polarizer directly attached to the image sensor (photodiode array) in accordance with an illustrative embodiment. FIG. 6 also shows the transmitted light path in the microscope. In FIG. 6, Sc is the light source (e.g., laser, light-emitting diode, etc.), F is a bandpass filter, LCP is a left circular polarizer, RCP is a right circular polarizer, C is a condenser, Sp refers to the specimen under investigation, and O is an objective lens. In alternative embodiments, the microscope of FIG. 6 can include fewer, additional, and/or different components.

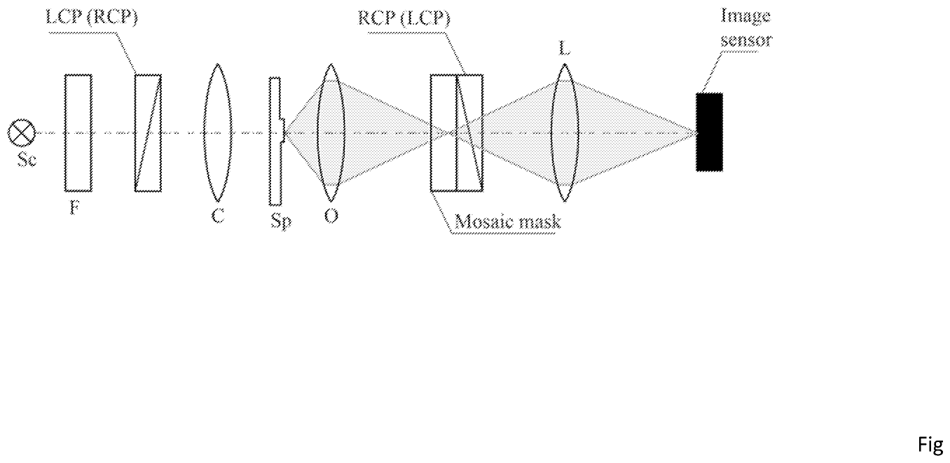

FIG. 7 depicts an example of an instant polarized light microscope in which the birefringent mosaic mask and circular polarizer are placed in a plane that is conjugated with the image sensor (i.e., intermediate image plane) in accordance with an illustrative embodiment. In this embodiment, the objective lens creates an image of the specimen on the mosaic mask, and the projection lens images the mosaic mask and the specimen on the image sensor. In addition to the various components shown in FIG. 6, the embodiment of FIG. 7 includes the projection (or relay) lens, represented by L in the figure.

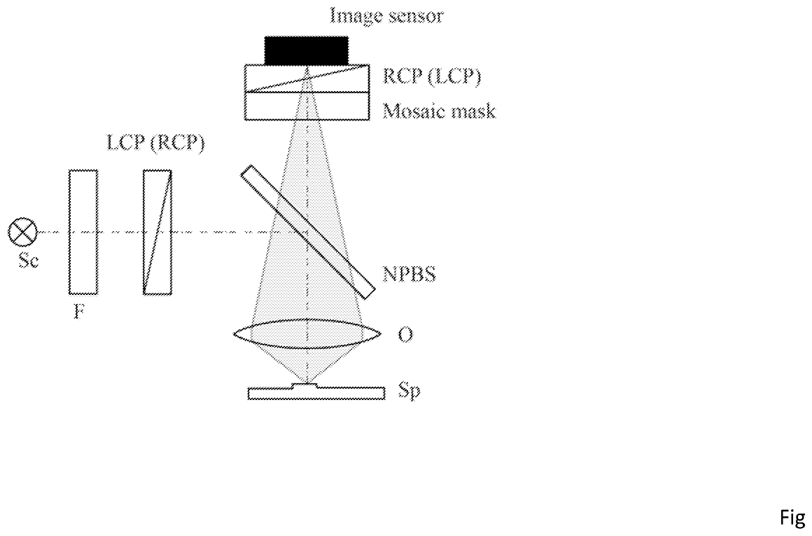

FIG. 8 is a schematic of an instant polarized light microscope with a reflected light path in accordance with an illustrative embodiment. In the embodiment of FIG. 8, the circularly polarized light beam is reflected toward the specimen by a non-polarizing beam splitter. In this example, the birefringent mosaic mask is placed directly on the image sensor. In addition to the various components shown in FIGS. 6 and 7, the embodiment of FIG. 8 also includes the non-polarizing beam splitter, represented by NPBS in the figure.

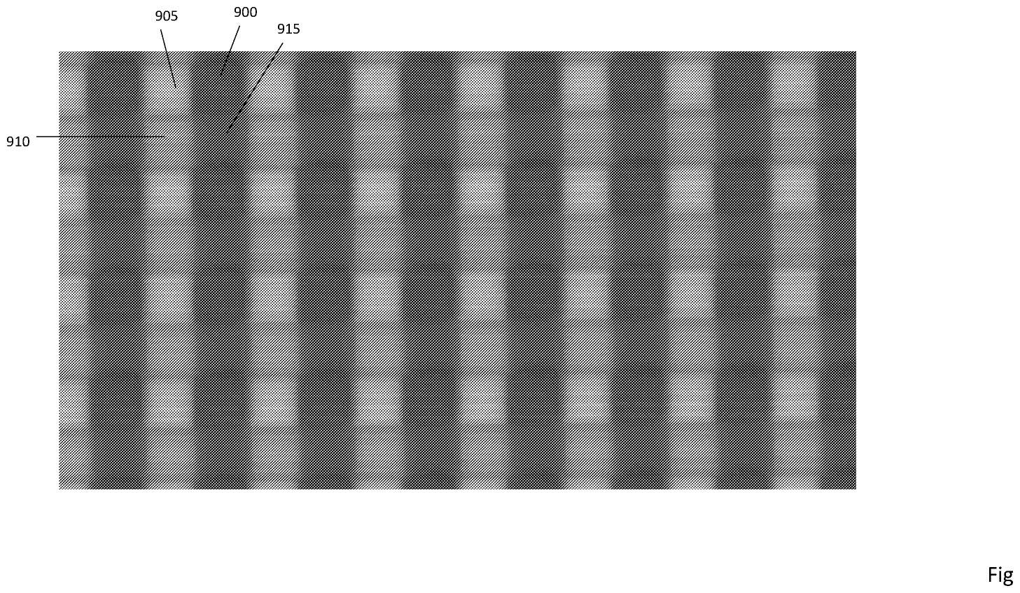

FIG. 9 depicts a birefringent mosaic mask written (nanofabricated) by laser pulses inside a quartz substrate in accordance with an illustrative embodiment. The image of FIG. 9 was captured by a polychromatic polarizing microscope. In FIG. 9, the hue corresponds to the slow axis orientation and the brightness is proportional to the retardation. The mask is designed to work with a Lumenera camera Infinity 8-2M. The mask superpixel includes four pixels, where a first pixel 900, a second pixel 905, and a third pixel 910 have retardation 20 nm, and a fourth pixel 915 has no retardation. Additionally, the first pixel 900 has a slow axis orientation of φ=0°, the second pixel 905 has a slow axis orientation of φ=60°, and the third pixel 910 has a slow axis orientation of φ=120°. A pixel size of the mosaic mask is 9 μm×9 μm, which is the same as pixel size in Infinity 8-2M. In alternative embodiments, the mosaic mask can have a different pixel size compatible with a different type of camera (i.e., image sensor).

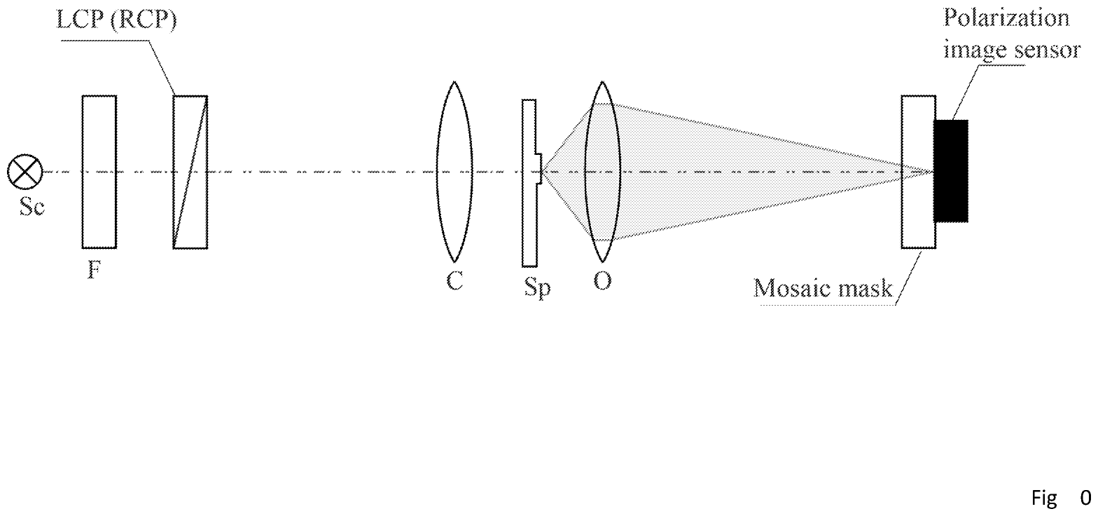

FIG. 10 depicts an instant polarized light microscope with a birefringent mosaic mask and a polarization image sensor in accordance with an illustrative embodiment. In an illustrative embodiment, the polarization image sensor can be a Sony polarization image sensor that includes an on-chip lens, a polarizer, and a photodiode. In an alternative implementation, the embodiment of FIG. 10 can also include a relay (or projection) lens similar to the embodiment of FIG. 7.

In an illustrative embodiment, all of the possible states of polarization of light can be represented by a set of four real quantities, called the Stokes parameters, each of which has the dimensions of intensity. In terms of the Cartesian components the four Stokes parameters, denoted by S₀, S₁, S₂ and S₃, are defined as follows:

$$\begin{matrix}{S}_{0} = {I}_{0} = ( {I}_{x} + {I}_{y} ) = ( {I}_{- 45 °} + {I}_{+ 45 °} ) = ( {I}_{ℓ} + {I}_{r} ) , \\ {S}_{1} = {I}_{x} - {I}_{y} , \\ {S}_{2} = {I}_{+ 45 °} - {I}_{- 45 °} , \\ {S}_{3} = {I}_{r} - {I}_{ℓ} .\end{matrix} \qquad Equation ( s ) 1$$

In particular, I₀ denotes the total intensity of the light wave, Iₓ, I_{y}, I_{+45°}, I_{-45°}, Iᵣ and Iₜ represents the intensities transmitted by an ideal variable polarizer placed in the path of the wave and adjusted to transmit the x, y, +45°, −45° linear polarizations and the (l)—left and (r)—right circular polarizations, respectively. These polarizations are called the degenerate polarizations. The proposed birefringent mosaic mask can be used for the instant mapping of all Stokes parameters. Such a device is called an instant imaging full Stokes polarimeter. Described below are three examples of schematics for instant imaging full Stokes polarimeters.

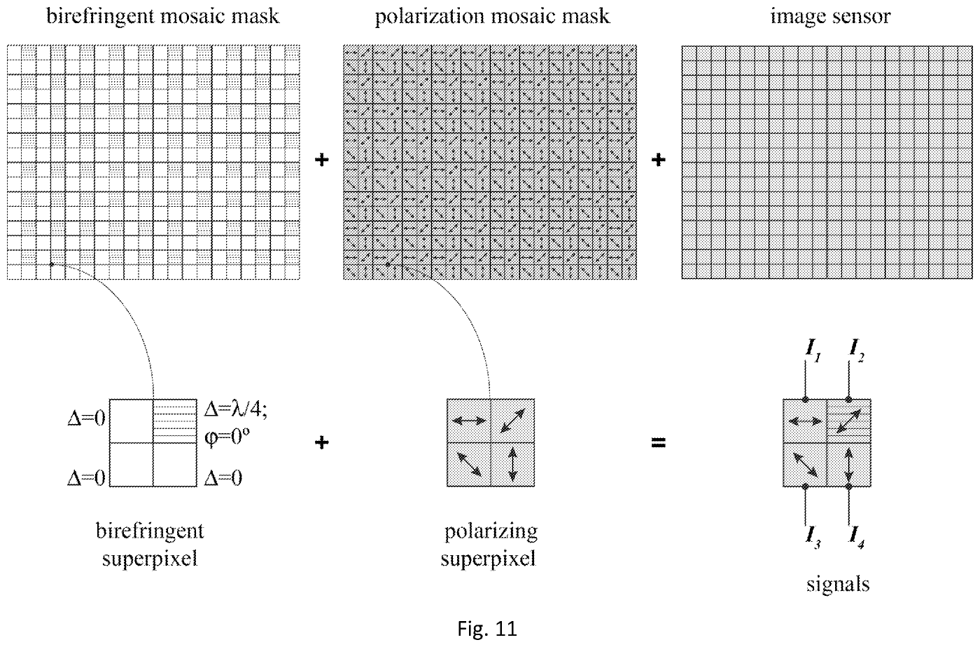

FIG. 11 depicts a birefringent mosaic mask for full Stokes polarization parameters imaging with a polarization imaging chip in accordance with an illustrative embodiment. The top row in FIG. 11 shows a combination of the proposed birefringent mosaic mask and a polarization mosaic mask, which covers an image sensor. The combination of a polarization mask and an image sensor is called a polarization image sensor, and it is currently available on the market (for example, Sony IMX250MZR). The bottom row displays superpixels in birefringent and polarization masks, and their mutual arrangement. The birefringent superpixel is formed of three pixels with no birefringence and one birefringent pixel with quarterwave retardation (Δ=λ/4) and horizontal slow axis (φ=0°). The polarization superpixel is formed of four micropolarizers with principal axes oriented in horizontal (x), vertical (y), and ±45° directions. The image sensor superpixel generates signals I₁, I₂, I₃ and I₄, which allow for computation of all Stoke parameters as follows:

$$\begin{matrix}{S}_{0} = {I}_{1} + {I}_{4} , \\ {S}_{1} = {I}_{1} - {I}_{4} , \\ {S}_{2} = {I}_{1} + {I}_{4} - 2 {I}_{3} , \\ {S}_{3} = {I}_{1} + {I}_{4} - 2 {I}_{2} .\end{matrix} \qquad Equation ( s ) 2$$

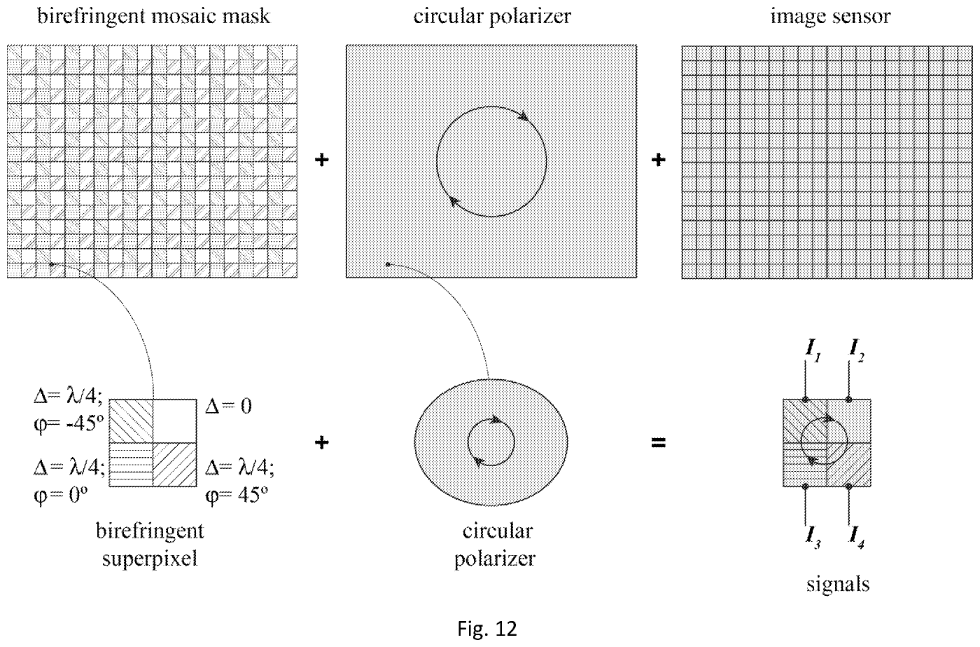

Currently available polarization image sensors employ wire-grid micro polarizers, which work relatively well in the longer wavelength range, from green to near infrared. In order to work with the shorter wavelength range, including blue, violet and near ultraviolet, one can use a polarimeter configuration, which is shown in FIG. 12. The top row in FIG. 12 shows a combination of the proposed birefringent mosaic mask, circular polarizer, and image sensor. The bottom row displays a superpixel in a birefringent mask, an area of the circular polarizer, and the corresponding image sensor superpixel. The birefringent superpixel is formed of one pixel with no birefringence and three birefringent pixels with quarterwave retardation (Δ=λ/4) and slow axes oriented in horizontal and diagonal directions (φ=−45°, 0°, and +45°). The image sensor superpixel generates signals I₁, I₂, I₃ and I₄, which allow for computation of all Stoke parameters using Equation(s) 2 above.

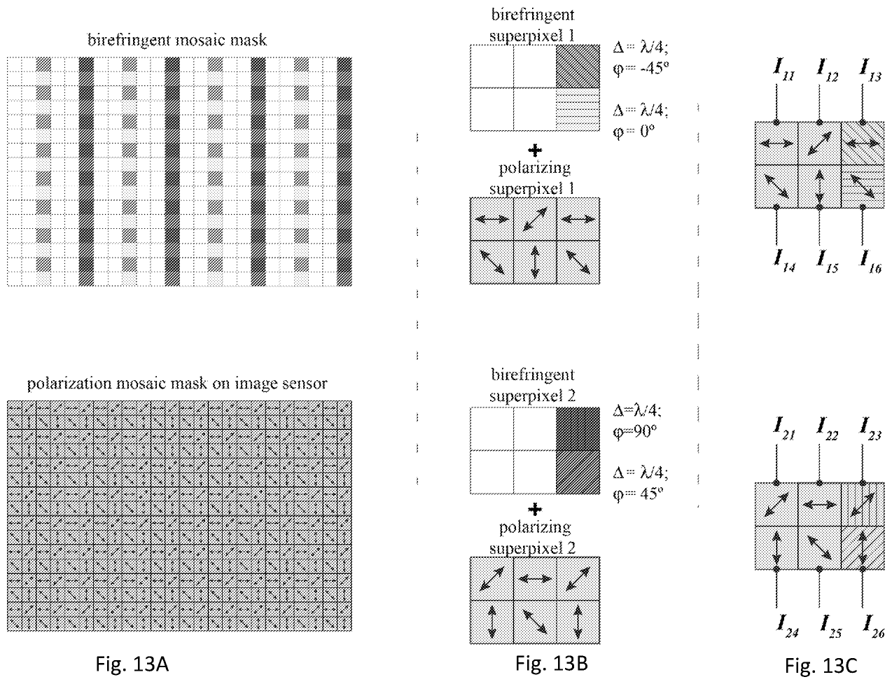

Two of the above-mentioned polarimeter schematics employ the sum operation for computing the last three Stokes parameters. Therefore these implementations could have increased noise and lower sensitivity. The polarimeter schematic in FIG. 13 employs only the subtraction operation. FIG. 13A depicts a birefringent mosaic mask for full Stokes polarization parameters imaging with a polarization imaging chip in accordance with an illustrative embodiment. FIG. 13B depicts two superpixels of the birefringent mosaic mask in accordance with an illustrative embodiment. FIG. 13C depicts two sets of six signals, which are generated by two superpixels of the birefringent mosaic mask, in accordance with an illustrative embodiment. In the embodiment of FIG. 13, the proposed mosaic mask is used in combination with a polarization image sensor (e.g., the above-mentioned Sony polarization imaging chip), which allows the device to receive all four Stokes polarization parameters of the image instantly. The mask includes two sets of superpixels of six pixels each, in which four right pixels with no birefringence and two left birefringent pixels with quarterwave retardation (Δ=λ/4). The direction of hatch pattern depicts the slow axis orientation φ, −45° and 0° in the first superpixel, and 90° and 45° in the second superpixel.

The first image sensor superpixel generates signals I₁₁, I₁₂, I₁₃, I₁₄, I₁₅, and I₁₆, which allows for computation of all Stoke parameters as follows:

$$\begin{matrix}{S}_{0} = {\sum }_{k = 1}^{6} {I}_{1 k} , \\ {S}_{1} = {I}_{11} - {I}_{15} , \\ {S}_{2} = {I}_{12} - {I}_{14} , \\ {S}_{3} = {I}_{12} - {I}_{16} .\end{matrix} \qquad Equation ( s ) 3$$

The second image sensor superpixel generates signals I₂₁, I₂₂, I₂₃, I₂₄, I₂₅, and I₂₆, which allows for computation of all Stoke parameters as follows:

$$\begin{matrix}{S}_{0} = {\sum }_{k = 1}^{6} {I}_{2 k} , \\ {S}_{1} = {I}_{22} - {I}_{24} , \\ {S}_{2} = {I}_{21} - {I}_{25} , \\ {S}_{3} = {I}_{26} - {I}_{23} .\end{matrix} \qquad Equation ( s ) 4$$

Thus, described herein are methods and systems for a nanofabricated birefringent mosaic mask with an attached uniform circular polarizer that can be added to a photodiode array. The proposed sensor has high sensitivity for subtle changes of polarization in the image instantly. In one implementation, the birefringent mosaic mask can be incorporated into an instant polarized light microscope to form a polarization image sensor with enhanced sensitivity for low polarization distortion. In another implementation, the birefringent mosaic mask can be used to create an instant full Stokes camera that provides instant full Stokes polarization parameters imaging.

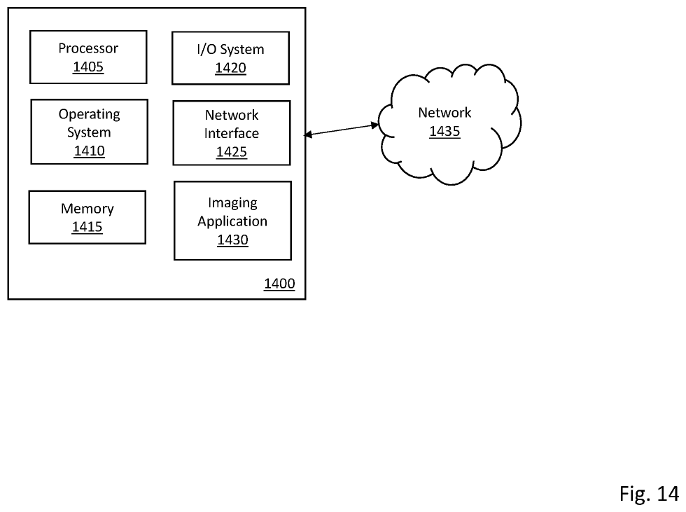

In an illustrative embodiment, operation of the instant polarized light microscope or full Stokes camera can be performed by a computing system that includes a processor, memory, user interface, transceiver (i.e., receiver and/or transmitter), etc. Instructions for operating the microscope/camera can be stored in the memory and upon execution of the instructions by the processor, the computing system can control operation of the device. All or a portion of the computing system can be incorporated into a microscope in one embodiment. All or a portion of the computing system can also be in the form of a system that is remote from the microscope and used to control the system and/or perform operations. As an example, FIG. 14 is a block diagram of a computing system 1400 to implement a microscope imaging system in accordance with an illustrative embodiment. The computing system 1400 can communicate directly with other computing devices (e.g., servers, processors, etc.), or through a network 1435, depending on the implementation.

The computing system 1400 includes a processor 1405, an operating system 1410, a memory 1415, an input/output (I/O) system 1420, a network interface 1425, and an imaging application 1430. In alternative embodiments, the computing system 1400 may include fewer, additional, and/or different components. The components of the computing system 1400 communicate with one another via one or more buses or any other interconnect system. In embodiments in which the computing system is remote from the microscope, the computing system 1400 can be any type of computing device (e.g., tablet, laptop, desktop, smartphone, etc.) that has sufficient processing power to perform the operations described herein.

The processor 1405 can be in electrical communication with and used to control any of the system components described herein. For example, the processor can be used to execute the imaging application 1430, process received user selections, send data and commands to a microscope and/or imaging sensor, receive raw data from the microscope and/or imaging sensor, process the data using the algorithms described herein, etc. The processor 1405 can be any type of computer processor known in the art and can include a plurality of processors and/or a plurality of processing cores. The processor 1405 can include a controller, a microcontroller, an audio processor, a graphics processing unit, a hardware accelerator, a digital signal processor, etc. Additionally, the processor 1405 may be implemented as a complex instruction set computer processor, a reduced instruction set computer processor, an x86 instruction set computer processor, etc. The processor 1405 is used to run the operating system 1410, which can be any type of operating system.

The operating system 1410 is stored in the memory 1415, which is also used to store programs, microscope data, readings and settings, network and communications data, peripheral component data, the imaging application 1430, and other operating instructions. The memory 1415 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc. In some embodiments, at least a portion of the memory 1415 can be in the cloud to provide cloud storage for the system. Similarly, in one embodiment, any of the computing components described herein (e.g., the processor 1405, etc.) can be implemented in the cloud such that the system can be run and controlled through cloud computing.

The I/O system 1420 is the framework which enables users and peripheral devices to interact with the computing system 1400. The I/O system 1420 can include a display, one or more speakers, one or more microphones, a keyboard, a mouse, one or more buttons or other controls, etc. that allow the user to interact with and control the computing system 1400. The I/O system 1420 also includes circuitry and a bus structure to interface with peripheral computing devices such as power sources, universal service bus (USB) devices, data acquisition cards, peripheral component interconnect express (PCIe) devices, serial advanced technology attachment (SATA) devices, high-definition multimedia interface (HDMI) devices, proprietary connection devices, etc.

The network interface 1425 includes transceiver circuitry (e.g., a transmitter and a receiver) that allows the computing device 1400 to transmit and receive data to/from other devices such as a remote data processing center, individual microscope units, servers, websites, etc. The network interface 1425 enables communication through the network 1435, which can be one or more communication networks. The network 1435 can include a cable network, a fiber network, a cellular network, a wi-fi network, a landline telephone network, a microwave network, a satellite network, etc. The network interface 1425 also includes circuitry to allow device-to-device communication such as Bluetooth® communication.

The imaging application 1430 can include software and algorithms in the form of computer-readable instructions which, upon execution by the processor 1405, performs any of the various operations described herein such as controlling a light source, controlling an imaging sensor, extracting data from captured images, calculating Stokes parameters, etc. The imaging application 1430 can utilize the processor 1405 and/or the memory 1415 as discussed above. In an alternative implementation, the imaging application 1430 can be remote or independent from the computing system 1400, but in communication therewith.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A polarized light microscope comprising:
a light source configured to illuminate a specimen;
an imaging sensor configured to capture an image of the specimen;
a first circular polarizer positioned between the light source and the specimen;
a birefringent mosaic mask positioned between the specimen and the imaging sensor; and
a second polarizer positioned between the mask and the imaging sensor.

2. The microscope of claim 1, wherein the second polarizer and the birefringent mosaic mask are attached to the imaging sensor.

3. The microscope of claim 1, wherein the second polarizer and the birefringent mosaic mask are positioned in a plane that is conjugated with the image sensor.

4. The microscope of claim 1, further comprising an objective lens positioned between the specimen and the birefringent mosaic mask.

5. The microscope of claim 1, wherein the second polarizer comprises a circular polarizer.

6. The microscope of claim 1, wherein the second polarizer comprises a right circular polarizer, and the first polarizer comprises a left circular polarizer.

7. The microscope of claim 1, wherein a superpixel of the birefringent mosaic mask includes a first square, a second square, a third square, and a fourth square that have a retardation range from 0 to 0.25λ.

8. The microscope of claim 7, wherein the first square is not birefringent, wherein the second square, the third square, and the fourth square have the same retardation, which lies in a range from 0.01λ to 0.25λ, and wherein the second square has slow axis orientation of 0°, the third square has slow axis orientation of 60°, and the fourth square has slow axis orientation of 120°.

9. The microscope of claim 7, wherein the first square is not birefringent, wherein the second square, the third square, and the fourth square have the same retardation, which lies in a range from 0.01λ to 0.25λ, and wherein the second square has slow axis orientation of 0°, the third square has slow axis orientation of 45°, and the fourth square has slow axis orientation of 90°.

10. The microscope of claim 7, wherein the first square, the second square, the third square, and the fourth square have the same retardation, which lies in a range from 0.01λ to 0.25λ, and wherein the first square has slow axis orientation of 0°, the second square has slow axis orientation of 45°, the third square has slow axis orientation of 90°, and the fourth square has slow axis orientation of 135°.

11. The microscope of claim 1, wherein the birefringent mosaic mask includes two sets of superpixels.

12. The microscope of claim 1, wherein the birefringent mosaic mask is fabricated by way of laser pulses directed inside a quartz substrate.

13. The microscope of claim 1, wherein the birefringent mosaic mask is formed by a nanostructured surface.

14. The microscope of claim 1, wherein the birefringent mosaic mask is constructed from micro tiles made of a birefringent film.

15. An instant imaging full Stokes polarimeter, comprising:
a polarization image sensor that includes a polarizer and an imaging sensor;
a birefringent mosaic mask proximate to the polarization image sensor, wherein the birefringent mosaic mask includes a plurality of birefringent superpixels, and wherein each birefringent superpixel is formed of one or more pixels with no birefringence and one or more birefringent pixels; and
a processor operatively coupled to the polarization image sensor, wherein the processor is configured to process a plurality of intensity signals generated by the plurality of birefringent superpixels to identify Stokes parameters of an image captured by the imaging sensor.

16. The polarimeter of claim 15, wherein the polarizer comprises a polarization mosaic mask that includes a plurality of polarization superpixels, and wherein each polarization superpixel includes a plurality of micropolarizers.

17. The polarimeter of claim 15, wherein the polarizer comprises a circular polarizer.

18. The polarimeter of claim 15, wherein the birefringent mosaic mask is attached to one or more of the imaging sensor and the polarizer.

19. The polarimeter of claim 15, wherein the birefringent mosaic mask includes two sets of superpixels.

20. The polarimeter of claim 15, wherein each birefringent superpixel includes six pixels.
